(19) United States
(12) Patent Application Publication
(10) Pub. No.: US 2015/0199695 A1
(43) Pub. Date: Jul. 16, 2015

(54) Reporting on Technology Sector Sizes Using Patent Assets

(71) Applicant: Wisdomain Inc., Seongnam-si (KR)

(72) Inventors: ILSOO Kim, San Jose, CA (US); Seungho Jung, Anyang-si (KR)

(21) Appl. No.: 14/591,854

(22) Filed: Jan. 7, 2015

Related U.S. Application Data
(60) Provisional application No. 61/925,964, filed on Jan. 10, 2014.

(51) Int. Cl. G06Q 30/02; G06Q 50/18; G06Q 40/00

(52) U.S. Cl. CPC G06Q 30/0201; G06Q 40/00; G06Q 50/184

(57) ABSTRACT

System and methods for reporting on the size of a technology sector using patent assets. Information identifying a technology sector is received from a client device. A patent database is queried for a plurality of patent assets associated with the technology sector. An overall financial metric (e.g., revenue, research & development spend, net income) of the technology sector is estimated based on the plurality of patent assets associated with the technology sector. An output for the client device is generated based on the overall financial metric.

### CROSS-REFERENCE TO RELATED APPLICATION

This application claims priority from U.S. Provisional Patent Application No. 61/925,964, titled “Estimating Technology Sector Market Sizes Using Patent Assets” and filed on Jan. 10, 2014, the contents of which are incorporated by reference herein in its entirety.

### BACKGROUND

1. Field of the Disclosure

This disclosure pertains in general to analyzing technology sectors, and in particular to tools for reporting on sizes of technology sector using patent assets.

2. Description of the Related Art

When making investment decisions in a technology sector, it is helpful to know the size of a market in the technology sector. However, it is a technical challenge for software tools to estimate the market size of a technology sector due to a lack of public financial information from companies in the sector. Surveying various companies for this financial information is a difficult and expensive process. Even for companies that are required to publish financial information, the published information is typically not detailed enough for accurately estimating the market size of the technology sector. Thus, it is difficult for software tools to produce a report that accurately reflects the market size of a technology sector.

### SUMMARY

Embodiments of the present disclosure are related to tools for reporting on sizes of technology sectors using patent assets in those sectors. In one embodiment, a computer-implemented method for market analysis comprises receiving information identifying a technology sector from a client device. A patent database storing patent asset information is queried for patent assets associated with the technology sector. An overall financial metric (e.g., revenue, research & development spend, net income) of the technology sector is estimated based on the plurality of patent assets associated with the technology sector. An output (e.g., a report on the technology sector) is generated for the client device based on the overall financial metric of the technology sector.

In one embodiment, estimating the overall financial metric of the technology sector comprises estimating an overall revenue of the technology sector based on the plurality of patent assets associated with the identified technology sector.

In one embodiment, the method further comprises identifying a plurality of companies that own the plurality of patent assets associated with the technology sector. The overall financial metric of the technology sector is estimated based further on the identified plurality of companies that own the plurality of patent assets associated with the technology sector. Additionally, the overall financial metric of the technology sector can be estimated by accessing a financial database storing financial information for the plurality of companies.

In one embodiment, estimating the overall financial metric of the technology sector comprises determining, from the plurality of patent assets, a first number of patent assets that are owned by a company and are in the technology sector; determining a second number of patent assets owned by the company across a plurality of technology sectors; determining a total financial metric of the company; determining a financial metric of the company in the technology sector based on the first number of patent assets that are owned by the company and are in the technology sector, the second number of patent assets owned by the company across a plurality of technology sectors, and the total financial metric of the company; and estimating the overall financial metric of the technology sector based on the financial metric of the company in the technology sector.

In one embodiment, estimating the overall financial metric of the technology sector comprises determining, from the plurality of patent assets, a number of patent assets that are owned by at least one company and are in the technology sector; determining a financial metric per patent asset in the technology sector based on financial metrics of other companies in the technology sector; estimating the overall financial metric of the technology sector based on the financial metric per patent asset and the number of patent assets that are owned by the at least one company and are in the technology sector.

In one embodiment, estimating the overall financial metric of the technology sector comprises, for at least one patent asset of the patent assets, determining a respective financial metric for the patent asset based on a patent office classification of the patent asset; and estimating the overall financial metric of the technology sector based on the respective financial metric for the patent asset.

### BRIEF DESCRIPTION OF THE DRAWINGS

The teachings of the embodiments disclosed herein can be readily understood by considering the following detailed description in conjunction with the accompanying drawings.

FIG. 1 is a high-level block diagram of a computing environment for estimating market size of a technology sector, according to one embodiment.

FIG. 2 is a flowchart for a method for estimating market size of a technology sector, according to one embodiment.

FIG. 3 is a flowchart for the step of estimating a financial metric of a technology sector from FIG. 2, according to an embodiment.

FIG. 4 illustrates a technique for estimating revenue of a company in a technology sector when the total revenue of a company is known, according to an embodiment.

FIG. 5A illustrates a technique for estimating revenue per patent using patent office classifications, according to an embodiment.

FIG. 5B illustrates a technique for estimating revenue of a company in a technology sector using revenue per patent that is pre-calculated based on patent office classifications, according to an embodiment.

FIG. 6 illustrates the hardware architecture of a market estimation system according to one embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures and accompanying description depict various embodiments for purposes of illustration only. One skilled in the art will readily recognize from the following description that alternative embodiments of the structures and methods illustrated herein may be employed without departing from the principles described herein.

Embodiments of the present disclosure relate to tools for reporting on a size of a technology sector by using patent assets. A plurality of patent assets associated with a particular technology sector are identified by querying a patent database, and companies that own the patents are identified. A financial metric (e.g., revenue, research & development spend, net income, etc.) of the technology sector across all companies is estimated based on the plurality of patent assets associated with the technology sector and the companies that own the patents. By leveraging information about patents, a financial metric for the technology sector can be estimated with or without financial information about the companies in the technology sector.

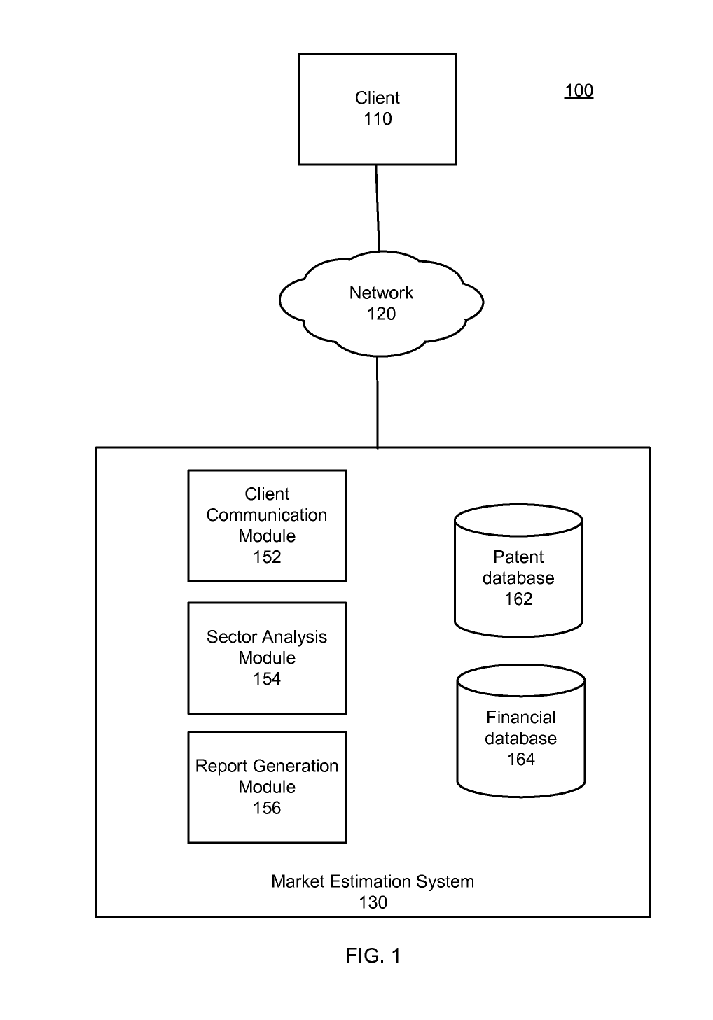

FIG. 1 is a high-level block diagram of a computing environment for estimating market sizes of a technology sector, according to one embodiment. The computing environment 100 includes a client 110 and a market estimation system 130 connected to a network 120. Only one client 110 is shown in FIG. 1 to simplify and clarify the description. Other embodiments of the computing environment 100 can have multiple of clients 110 communicating with the market estimation system 130 via the network 120.

The network 120 represents the communication pathways between the client 110 and market estimation system 130. In one embodiment, the network 120 can be an internal network or the Internet. In one embodiment, the network 120 uses standard communications technologies and/or protocols. Thus, the network 120 can include links using technologies such as Ethernet, 802.11, integrated services digital network (ISDN), digital subscriber line (DSL), asynchronous transfer mode (ATM), etc. Similarly, the networking protocols used on the network 120 can include the transmission control protocol/Internet protocol (TCP/IP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of the links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

In one embodiment, a client 110 is a computing device, such as a desktop computer, laptop computer, tablet computer, smartphone, etc. The client 110 executes a web browser, such as GOOGLE CHROME, that allows a user to make requests for market reports about a technology sector from the market estimation system 130, and to display market reports received from the market estimation system 130.

The market estimation system 130 estimates the market size of different technology sectors based on requests from the client 110 and generates a report for the technology sector that is transmitted to the client 110. In one embodiment, the market estimation system 130 is a server class computer or other computing device. As shown, the market estimation system 130 includes a client communication module 152, a sector analysis module 154, a report generation module 156, a patent database 162 and a financial database 164.

The client communication module 152 receives a request from the client 110 for a market report on a particular technology sector. A technology sector may refer to any area of technology. For example, the technology sector may be a broad technology sector such as “software” or a narrower technology sector such as “wireless speakers.” A myriad of possible technology sectors may be requested by the client 110 and are not limited to these specific examples. The client communication module 152 also transmits data outputs, such as market reports for the requested technology sector, to the client 110. In some embodiments, the request may be directly input to the market estimation system 130 through a user input device (e.g., keyboard) of the market estimation system 130 without using a client 110 or received from computer programs via pre-defined protocols (e.g., Application Programming Interface (API)).

The sector analysis module 154 generates a query for the requested technology sector and then searches the patent database 162 with the query to identify patent assets that are in the technology sector for a target time frame. The patent database 162 includes a large collection of patent assets. Patent assets include granted patents, patent publications, or both granted patents and patent publications. The patent assets may include United States (U.S.) patent assets, patent assets from other countries, regional patent assets (e.g., European Patent Office) and/or international patent assets (e.g., Patent Cooperation Treaty). The patent database 162 also maintains information about the patent assets, such as publication number, title, assignee information or applicant information specifying a company that owns the patent, the year of filing, the year of publication, the patent office classification (e.g., US patent classification, international patent classification), and other pertinent information that is typically printed on the face of a patent asset. The information may also include expiration status information (e.g. maintenance fee payments) for the patent assets and termination status information describing whether the patent assets have been terminated for any reason (e.g. abandonment).

The sector analysis module 154 uses the patent assets in the technology sector to estimate an overall financial metric for the technology sector across all of the companies in the technology sector. A financial metric is a quantitative statistic that provides an assessment of financial performance. In one embodiment the financial metric is revenue. Other types of financial metrics are research and development (R&D) spending, net income, etc. The financial metric can also be estimated over any fixed period of time, such as for a year, a half-year, a quarter-year, etc.

In specific, the sector analysis module 154 identifies companies that own the patents in the technology sector. Companies may include any legal entity, such as partnerships, corporations, etc. The sector analysis module 154 then searches (e.g. by querying) the financial database 164 for financial metrics of those companies, which it uses in estimating the overall financial metric for the technology sector as a whole. The financial database 164 stores financial information, including financial metrics, for a large number of companies across one or more countries. The financial metrics may be retrieved from publicly available sources of financial information, such as yearly 10-K statements filed with the Securities and Exchange Commission (SEC). For some companies, the financial database 164 may include exact financial metrics for the company that are divided into different technology sectors. However, for most companies the financial database 164 only has generic financial metrics for the company as a whole that are not specific to any particular technology sector.

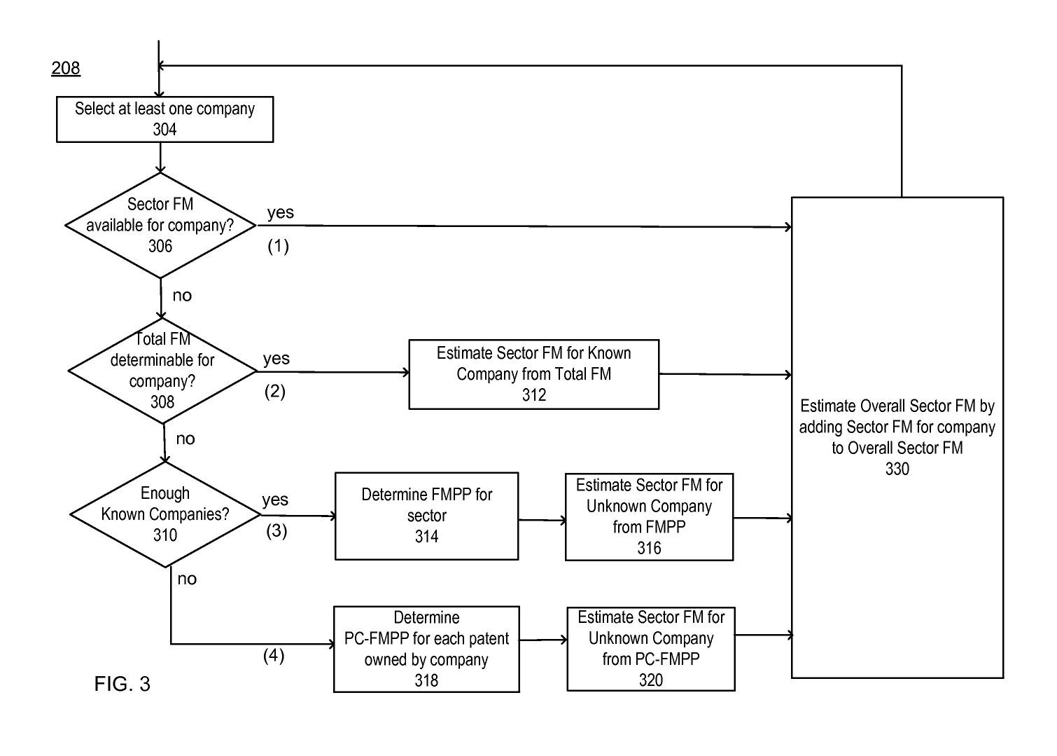

Several techniques may be used in estimating the overall financial metric for the technology sector depending on the amount of financial information available in the financial database 164 for the companies in the technology sector. In one embodiment the overall financial metric is generated for a specific technology sector in a target country for a target time frame (e.g. year). These techniques will be explained in greater detail by reference to FIGS. 3, 4, 5A and 5B.

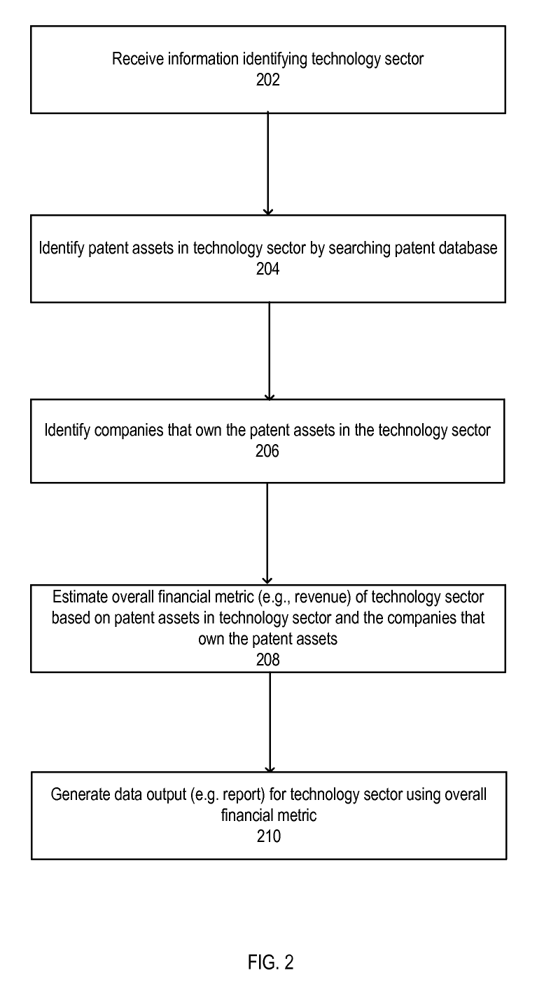

The report generation module 156 generates a market report on the market size of technology sector using the overall financial metric for the technology sector. The market report may include just the financial metric itself (e.g. revenue of $5.5 billion). The market report may include a graph generated using the overall financial metric that shows trends in the overall financial metric over time. In other embodiments, the report can be generated using company specific financial metrics, financial metrics per patent statistics, or any other financial metric that is described with respect to FIG. 2 through FIG. 5B. For example, the market report may also include a pie chart generated using the overall financial metric and company specific financial metrics that illustrate how different companies are positioned in the technology sector.

Referring now to FIG. 2, illustrated is a flowchart for a method for estimating market sizes of a technology sector, according to one embodiment. In one embodiment, the steps of FIG. 2 can be performed by the modules of the market estimation system 130.

In step 202, the market estimation system 130 receives information identifying a technology sector. The information may be in a request for a market report on a technology sector that is received from the client 110. Alternatively, the information may be in a request for a market report on a technology sector that is input directly into the market estimation system 130 or received via an API. The request for the market report may also include other information that defines the scope of the requested market report, such as information describing a particular country or year of interest for the market report.

In step 204, the market estimation system 130 identifies patent assets in the requested technology sector by searching the patent database 162. The patent database 162 is searched by generating a search query that is provided to the patent database 162. The search query may be formulated only to identify patent assets within a target time-frame and within a target country. For example, if the technology sector is “wireless speakers” the search query may be a Boolean search query such as “specification=wireless speakers AND filed=2012 AND country=US.” This search query searches for patents that include the text of wireless speakers, are first filed in 2012, and were filed in the United States. Another example of a search query is “specification=wireless speakers AND unexpired=2012 AND country=US.” This search query searches for patents that include the text of wireless speakers, are unexpired as of 2012, and were filed in the United States.

The patent database 162 returns a list of patents assets that match the search query. The matching can be performed with a text matching algorithm that searches the text of each patent asset to identify patent assets that exactly match the search query or are deemed to be sufficiently related to the search query. A number of different search algorithms can be used to identify a list of patent assets that best match the search query.

In one embodiment, the market estimation system 130 identifies patent assets for a target time frame from patent assets having a filing date that falls within the target time frame. For example, if a market report is being generated for the year 2012, the market estimation system 130 identifies patent assets that were filed in 2012 while excluding patent assets filed in other years. In another embodiment, the market estimation system 130 identifies patent assets that are enforceable during the target time frame. Patent assets are generally enforceable if they are issued as patents and have not yet expired or been terminated.

In other embodiments different techniques may be used for identifying the patent assets for a target time frame, such as using earliest priority date or publication date to filter the patent assets. Additionally, the time frame for the identified patent assets may be the same as or different than the time frame for the market report. For example, the patent assets published in late 2013 and early 2014 can be combined with financial information from 2012 to estimate the financial metric for a technology sector in 2012. This is because publication typically lags filing by approximately 18 months.

In one embodiment, the market estimation system 130 identifies one or more types of patent assets. For example, the market report can be generated from issued patents, patent publications, or both issued patents and patent publications.

In step 206, the market estimation system 130 identifies companies that own the identified patent assets in the requested technology sector. The companies can be identified by querying the patent database 162 for assignment and/or applicant information associated with the identified patent assets.

In step 208, the market estimation system 130 estimates an overall financial metric (e.g., revenue) of the technology sector for a target time frame based on the patent assets in the technology sector and the companies that own the patent assets. The market estimation system 130 generally calculates a sector financial metric on a company by company basis, and then sums together the company specific sector financial metrics to generate an overall financial metric for the entire technology sector across all companies. In one embodiment the financial metric is generated for a specific technology sector in a specific country in a particular year. Step 208 will be explained in greater detail by reference to FIG. 3.

In step 210, the market estimation system 130 generates a data output, such as a market report for the technology sector, using the overall financial metric. The market report can then be transmitted to the client 110 for display at the client 110, displayed directly at the market estimation system 130 or transmitted to requesting computer programs via pre-defined protocols (e.g., API). A report is one example of a data output, and other types of data outputs providing information about the technology sector can also be generated using the overall financial metric for the technology sector.

FIG. 3 is a flowchart for the step of estimating a financial metric of a technology sector from FIG. 2 in greater detail, according to an embodiment. The flowchart of FIG. 3 effectively illustrates four alternative techniques for estimating the overall financial metric (e.g. total revenue) of a technology sector across all companies in the sector. The four techniques may be combined or used individually to achieve an accurate estimate of the overall financial metric for the technology sector, and are labeled with notations of (1) through (4) in FIG. 3.

In step 304, the market estimation system 130 selects one or more companies for analysis. In one embodiment, the patent assets in the technology sector and financial metrics are analyzed on a company by company basis until all of the patent assets in the technology sector are accounted for.

In step 306, the market estimation system 130 determines whether a sector specific financial metric (“Sector FM”) is available for the selected company in the financial database 164 for a target time frame. The financial database 164 is accessed to determine if Sector FM for the company is available in the financial database 164 for the company. The most accurate way to estimate the Sector FM for a company is when the Sector FM is already known for a company. Thus, if the Sector FM for the company is available, in step 330, the overall financial metric for the technology sector (“Overall Sector FM”) is estimated by adding the Sector FM for the company to the Overall Sector FM. However, the Sector FM is not likely to be available for most companies. If the Sector FM is not available for the company, the process proceeds to step 308.

In step 308, the market estimation system 130 determines whether a total financial metric (“Total FM”) (e.g., total yearly U.S. revenue) can be estimated for the company for a target time frame in a target country using information in the financial database 164. The Total FM represents the FM for a company attributed to all technology sectors and is not specific to a single technology sector. Companies for which the Total FM for a target time frame and target country can be determined are referred to herein as a “Known Company.”

In one embodiment, the financial database 164 is accessed to determine if Total FM for the company is already available in the financial database 164. In another embodiment, if Total FM for a company in a target country is not known, but the international FM for the company in all countries is known, the market estimation system 130 can estimate the Total FM for the company in a target country from the country's total gross domestic product (GDP) and country's total exports. The Total FM can be estimated using the following formula:

$$TotalFM = InternationalFM \frac{G D P - ExportAmount}{G D P}$$

where TotalFM is the FM for a target company in a target country, InternationalFM is the FM for a target company across all countries, GDP is the gross domestic product of the target country, and ExportAmount is the amount of the target country's exports. This estimation assumes that a proportion of a company's FM attributed to exports is related to the proportion of a country's GDP attributed to exports.

If the Total FM can be determined for a company, in step 312, the market estimation system 130 estimates the Sector FM for the Known Company from the Total FM with the following equation:

$$SectorFM = TotalFM \times \frac{NPSector}{NPTotal}$$

where NP Sector is the number of patent assets for the target time frame owned by the Known Company in the requested technology sector in a target country, and NP Total is the total number of patent assets for the target time frame owned by the Known Company regardless of and across all technology sectors in a target country.

NP Sector can be determined by counting the number of patent assets owned by the Known Company in the technology sector that fall within the target time frame (e.g., patent assets filed in 2012, patent assets enforceable in 2012). NP Total can be determined by counting the total number of patent assets owned by the Known Company that fall within the target time frame (e.g. patent assets filed in 2012, patent assets enforceable in 2012). Alternatively, NP total can be determined by counting the number of alive patent assets owned by the Known Company filed in past years, and adding to it the number of patent filings in the current year. This calculation assumes the patent activity of a company for a specific technology sector is proportional to the financial metric of the company in that technology sector. Thus, the ratio of patent assets in the requested technology sector can be used to estimate the financial metric (e.g. revenue) for that technology sector.

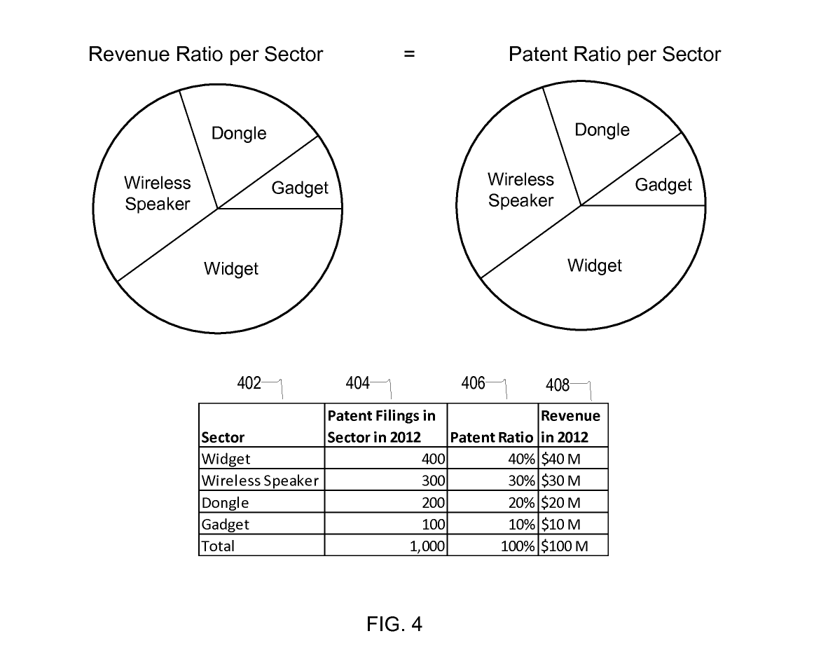

Referring briefly to FIG. 4, illustrated is a technique for estimating revenue of a company in a technology sector when the total revenue of the company is known, according to an embodiment. In FIG. 4, it is assumed that the financial metric of interest is revenue, the Known Company filed a total of 1,000 patent assets in 2012, and the Known Company has a revenue of $100 million in 2012. The first column 402 represents the technology sectors for the Known Company, the second column 404 represents the patent filings of the Known Company by technology sector, the third column 406 represents the ratio of the Known Company's patents by technology sector, and the fourth column 408 represents the estimated revenue by technology sector. The Known Company sells products in four technology sectors of widget, wireless speaker, dongle, and gadget. The company filed 400 widget patents, 300 wireless speaker patents, 200 dongle patents, and 100 gadget patents in 2012. Because 40% of the company's patent filings are in widgets, the widget revenue of the Known Company is estimated to be $40 million for 2012, which is 40% of the Known Company's yearly revenue. Similarly, because 30% of the Known Company's patent filings are in wireless speakers, the wireless speaker revenue of the Known Company is estimated to be $30 million for 2012.

In other embodiments, the second column 404 may be the enforceable patent assets in 2012. In this embodiment, there would be 400 widget patents, 300 wireless speaker patents, 200 dongle patents, and 100 gadget patents enforceable in 2012.

Referring back to FIG. 3, the process of estimating Sector FM shown in step 312 is possible when the Total FM of a company is known. However, the Total FM for a company is not always available. For example, some companies are private companies that do not release any public financial data. If the Total FM for a company is not known (“Unknown Company”), it is not possible to estimate the Sector FM for the company using the technique in step 312. Thus, if the Total FM for a company is not known, the process proceeds to step 310.

In step 310, the market estimation system 130 determines whether there are enough Known Companies in the technology sector (e.g., other companies for which total revenue can be determined for a target time frame and target country). For example, the market estimation system 130 can determine whether there are more than a threshold number of Known Companies. If so, in step 314, the market estimation system 130 determines a representative financial metric of each patent asset in the technology sector from the Total FM of the Known Companies in the technology sector for the target time frame. This representative financial metric represents the financial contribution attributed to a patent and is referred to as a financial metric per patent (“FMPP”). The FMPP is calculated for a Known Company by dividing the Sector FM for the Known Company by the number of patent assets in the technology sector for the target time frame owned by the Known Company. The FMPP from different Known Companies is then combined using a statistical technique, such as by determining the average of the FMPPs or a median FMPP, to obtain a final FMPP for the technology sector.

For example, suppose that in 2012, Known Company A has revenue in the wireless speaker sector of $30 million and filed 300 patents assets for wireless speakers (or alternatively, had 300 enforceable patents for wireless speakers during 2012). The revenue per patent for Known Company A in the wireless speaker sector is thus $100,000 per patent. Known Company B has revenue in the wireless speaker sector of $20 million and filed 100 patent assets for wireless speakers in 2012. The revenue per patent for Known Company B is thus $200,000 per patent. The two numbers can be averaged to result in revenue per patent of $150,000 for the wireless speaker sector in 2012.

In step 316, the Sector FM for the Unknown Company is calculated by multiplying the FMPP for the technology sector and the number of patent assets owned by the Unknown Company in the technology sector for the target time frame. For example, if the FMPP estimated from Known Companies is $150,000 for the wireless speaker sector, and Unknown Company C filed 100 patent assets for wireless speakers in 2012, the Sector FM for Unknown Company C is estimated at $15 million.

Thus, when financial information for a company is not available, step 310 and step 314 uses known financial information about other companies in the technology sector to infer the Sector FM for the company. The process of estimating Sector FM shown in step 314 and 316 is only useful when there are a statistically significant number of Known Companies. However, there may be situations where there are no Known Companies or only a few Known Companies. In this situation, the FMPP calculated in step 314 will not be a meaningful number. Thus, if there are not enough Known Companies, the process proceeds to step 318.

In step 318, the market estimation system 130 determines, for each patent asset owned by the company, a representative financial metric for the patent asset from the patent office classification for the patent. This representative financial metric is referred to as a patent office classification financial metric per patent (“PC-FMPP”). In one embodiment the PC-FMPP is pre-calculated and stored in the market estimation system 130, and the market estimation system 130 determines the PC-FMPP by retrieving the pre-calculated PC-FMPP associated with each patent asset. In another embodiment, the PC-FMPP can be determined by calculating the PC-FMPP in real-time.

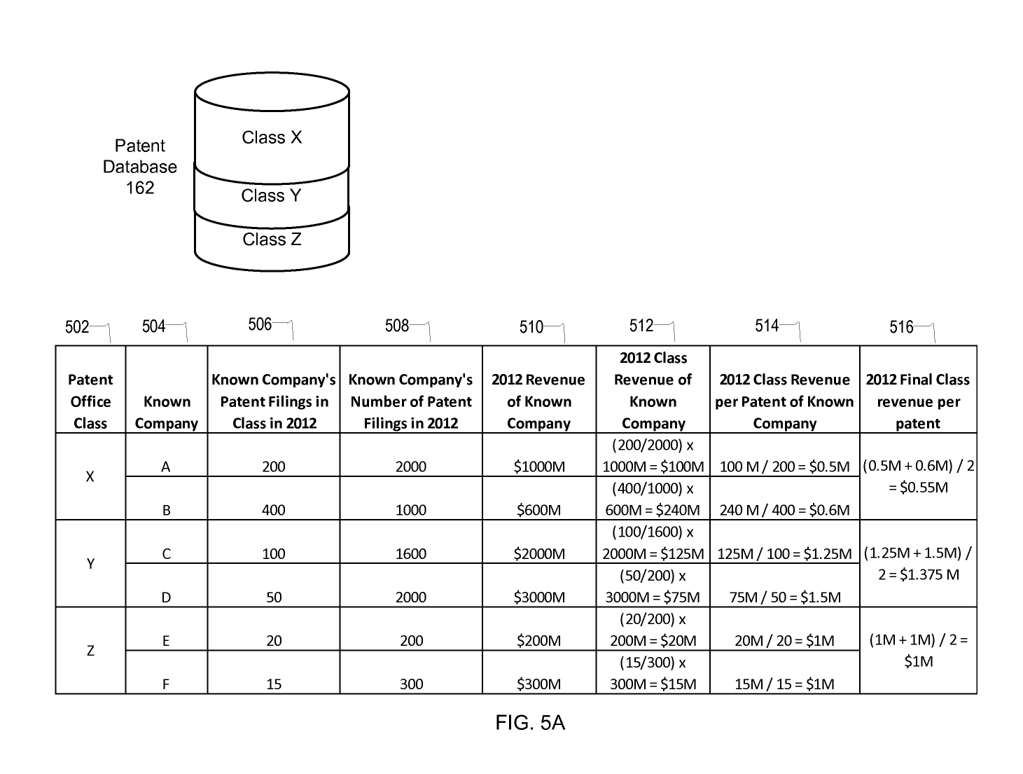

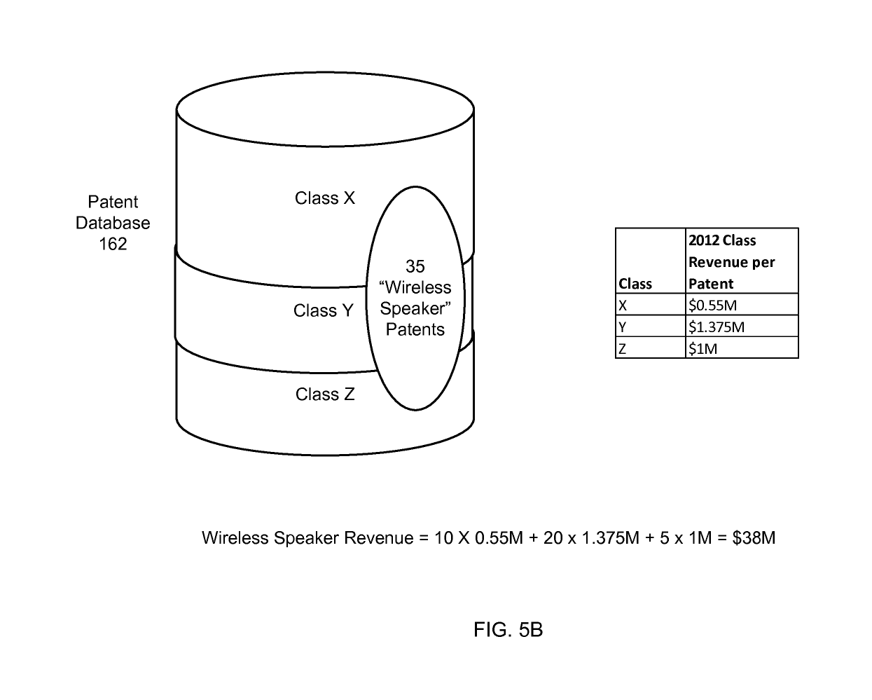

Referring to FIG. 5A, illustrated is a technique for estimating revenue per patent using patent office classifications, according to an embodiment. This example assumes that the financial metric of interest is revenue and all of the patents in the patent database 162 are classified into one of three patent office classes 502: X, Y or Z. For each classification, Known Companies 504 that have patents in the classification for a target time frame are determined. For each Known Company, a number of patents 506 owned by the Known Company in the class for a target time frame and the total number of patents 508 owned by the Known Company for the target time frame are determined from the patent database 162. The revenue 510 of the Known Company for the target time frame is determined from the financial database 164. The class revenue 512 of the Known Company is determined by multiplying the total revenue of the company by a ratio of patents in the class to total patents. The class revenue per patent 514 of the Known Company is determined by dividing the class revenue by the number of patents in the class. The final class revenue per patent 516 is then estimated by averaging the class revenue per patent across different Known Companies.

For example, Known Company A filed 2000 total patents assets in 2012, of which 200 are in class X (or alternatively, Known Company A owned 2000 enforceable patent assets in 2012). Known Company A also has $1000 million (“M”) or $1 billion in revenue during 2012. The class revenue of Known Company A in class X is calculated to be $100 million. The class revenue per patent of Known Company A in class X is calculated to be $0.5 M. The same process is repeated for Known Company B to generate a class revenue per patent of $0.6 M in class X. The two numbers are then averaged to produce a final class revenue per patent of $0.55 M for class X for 2012. The same process is repeated for class Y and class Z to estimate a class revenue per patent of $1.375 M for class Y and class revenue per patent of $1 M for class Z.

Each patent in the patent database is assigned a PC-FMPP according to the classification of the patent. This process assumes that all patents in a given classification have a similar FM attributed to them regardless of who owns the patents, e.g. all patents in class X have the same revenue of $0.55 M attributed to them for 2012, regardless of the company that owns the patents. Determining the PC-FMPP of a patent from the patent office classification of a patent allows the FM attributed to a patent to be determined even if financial information of other companies in the same technology sector are not known. In one embodiment, if a patent belongs to multiple classes, the first class listed on the patent determines the PC-FMPP assigned to the patent. In another embodiment, if a patent belongs to multiple classes, the PC-FMPPs for the different classes may be averaged into an average PC-FMPP for the patent.

As another example, in FIG. 5A, the third column 506 may be Known Company's enforceable patent assets in the class during 2012 instead of patent filings in the class during 2012. Additionally, the fourth column 508 may be Known Company's enforceable patent assets in 2012 instead of Known Company's patent filings in 2012.

Referring back to FIG. 3, in step 320, the Sector FM for the Unknown Company is estimated from the PC-FMPP numbers. For example, the PC-FMPP of each of the Unknown Company's patents in the sector can be summed together to calculate the Sector FM. The Sector FM of a company is thus estimated even if financial information about the company or financial information about other companies in the same technology sector is not available for the target time frame.

Referring to FIG. 5B, illustrated is a technique for estimating a revenue of a company in a technology sector using revenue per patent that is pre-calculated based on patent office classifications, according to an embodiment. This example builds on the example of FIG. 5A and assumes that all patents fall into one of three classifications: X, Y and Z. The 2012 class revenue per patent is $0.55 M for class X, $1.375 M for class Y, and $1 M for class Z as pre-calculated in FIG. 5A. The requested technology sector is “wireless speakers.” There are 35 patent assets in the technology sector of wireless speaker for this Unknown Company for 2012: 10 class X patent assets, 20 class Y patent assets, and 5 class Z patent assets. Thus, the revenue in the wireless speaker sector for this company is $38 M (10×0.55 M+20×1.375 M+5×1 M=$38 M) in the year 2012.

Referring back to FIG. 3, in step 330, the Overall Sector FM is estimated by adding the Sector FM for the company to the Overall Sector FM. Regardless of whether technique (1), (2), (3) or (4) is used to estimate the Sector FM for a company, the result is added to the Overall Sector FM to increase the Overall Sector FM. The steps in FIG. 3 are repeated until all of the patents in the requested technology sector and companies that own those patents are processed.

FIG. 3 thus presents four alternative techniques for determining a financial metric (e.g., revenue) of a technology sector. The techniques may be combined as needed to generate the financial metric, depending on the amount of financial information that is available in the financial database 164. Technique (1) obtains a known Sector FM for a company when it is available, and likely produces the most accurate Sector FM. Technique (2) estimates the Sector FM when the Sector FM is not known, but financial information for the company is available. Technique (3) estimates the Sector FM when financial information for the company is not available, but financial information for other companies in the technology sector is available. Finally, technique (4) estimates the sector FM when there is limited financial information about any company in the technology sector. Techniques (3) and (4) may also be utilized when the company that owns a patent is not known.

Embodiments herein thus improve upon estimating market sizes of technology sectors. The system leverages knowledge of patent assets in the technology sector and companies associated with those patent assets to more accurately predict financial metrics for a given technology sector. Further, the system can estimate financial metrics with or without financial information for the companies in the technology sector.

### Example Computer Architecture

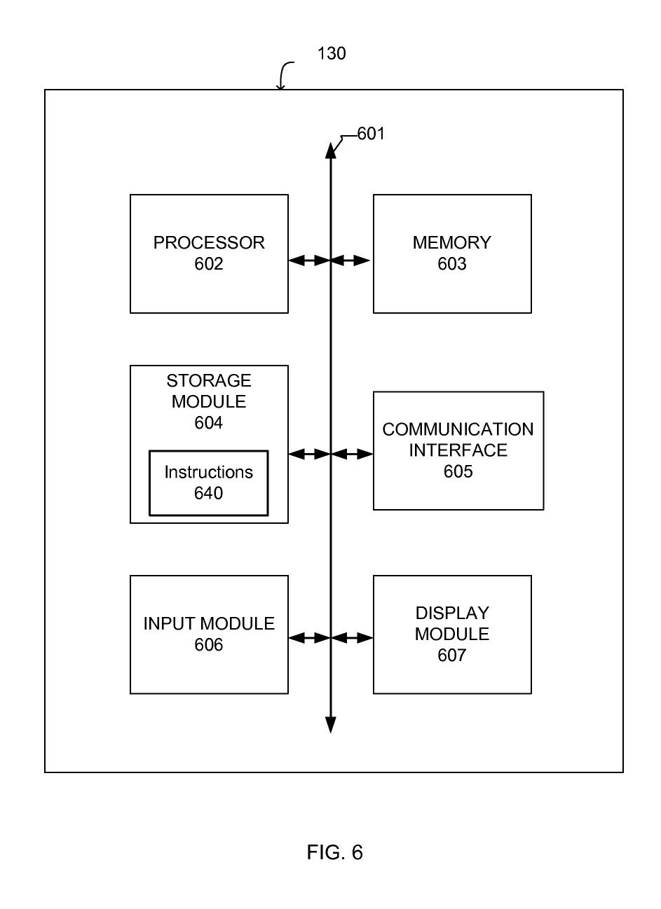

FIG. 6 illustrates the hardware architecture of a market estimation system 130, according to one embodiment. In one embodiment, the a market estimation system 130 is a server computer including components such as a processor 602, a memory 603, a storage module 604, an input module (e.g., keyboard, mouse, and the like) 606, a display module 607 and a communication interface 605, exchanging data and control signals with one another through a bus 601. The storage module 604 is implemented as one or more non-transitory computer readable storage media (e.g., hard disk drive), and stores software instructions 640 that are executed by the processor 602 in conjunction with the memory 603 to implement the market analysis described herein. For example, the storage module 604 may include software instructions 640 in the form of the client communication module 152, sector analysis module 154, or report generation module 156. Operating system software and other application software may also be stored in the storage module 604 to run on the processor 602.

Upon reading this disclosure, those of skill in the art will appreciate still additional alternative designs for market analysis for a technology sector using patents. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A system, comprising:
a patent database storing patent asset information;
at least one non-transitory computer readable medium storing processor executable instructions for:
receiving, from a client device, information identifying a technology sector;
querying the patent database for a plurality of patent assets associated with the technology sector;
estimating an overall financial metric of the technology sector based on the plurality of patent assets associated with the identified technology sector; and
generating an output for the client device based on the overall financial metric of the technology sector.

2. The system of claim 1, wherein estimating the overall financial metric of the technology sector comprises estimating an overall revenue of the technology sector based on the plurality of patent assets associated with the identified technology sector.

3. The system of claim 1, the instructions further comprising instructions for:
identifying a plurality of companies that own the plurality of patent assets associated with the technology sector;
wherein the overall financial metric of the technology sector is estimated based further on the identified plurality of companies that own the plurality of patent assets associated with the technology sector.

4. The system of claim 3, further comprising:
a financial database storing financial information for the plurality of companies;
wherein the overall financial metric of the technology sector is estimated by accessing the financial information for the plurality of companies stored in the financial database.

5. The system of claim 1, wherein estimating the overall financial metric of the technology sector comprises:
determining, from the plurality of patent assets, a first number of patent assets that are owned by a company and are in the technology sector;
determining a second number of patent assets owned by the company across a plurality of technology sectors;
determining a total financial metric of the company;
determining a financial metric of the company in the technology sector based on the first number of patent assets that are owned by the company and are in the technology sector, the second number of patent assets owned by the company across a plurality of technology sectors, and the total financial metric of the company; and
estimating the overall financial metric of the technology sector based on the financial metric of the company in the technology sector.

6. The system of claim 1, wherein estimating the overall financial metric of the technology sector comprises:
determining, from the plurality of patent assets, a number of patent assets that are owned by at least one company and are in the technology sector;
determining a financial metric per patent asset in the technology sector based on financial metrics of other companies in the technology sector; and
estimating the overall financial metric of the technology sector based on the financial metric per patent asset and the number of patent assets that are owned by the at least one company and are in the technology sector.

7. The system of claim 1, wherein estimating the overall financial metric of the technology sector comprises:
for at least one patent asset of the patent assets:
determining a respective financial metric for the patent asset, the respective financial metric being based on a patent office classification of the patent asset; and
estimating the overall financial metric of the technology sector based on the respective financial metric for the patent asset.

8. The system of claim 1, wherein generating the output for the client device comprises generating a report of the technology sector based on the overall financial metric of the technology sector.

9. A computer-implemented method, comprising:
receiving, from a client device, information identifying a technology sector;
querying a patent database for a plurality of patent assets associated with the technology sector;
estimating an overall financial metric of the technology sector based on the plurality of patent assets associated with the identified technology sector; and
generating an output for the client device based on the overall financial metric of the technology sector.

10. The method of claim 9, wherein estimating the overall financial metric of the technology sector comprises estimating an overall revenue of the technology sector based on the plurality of patent assets associated with the identified technology sector.

11. The method of claim 9, further comprising:
identifying a plurality of companies that own the plurality of patent assets associated with the technology sector;
wherein the overall financial metric of the technology sector is estimated based further on the identified plurality of companies that own the plurality of patent assets associated with the technology sector.

12. The method of claim 11, wherein the overall financial metric of the technology sector is estimated by accessing a financial database storing financial information for the plurality of companies.

13. The method of claim 9, wherein estimating the overall financial metric of the technology sector comprises:
determining, from the plurality of patent assets, a first number of patent assets that are owned by a company and are in the technology sector;
determining a second number of patent assets owned by the company across a plurality of technology sectors;
determining a total financial metric of the company;
determining a financial metric of the company in the technology sector based on the first number of patent assets that are owned by the company and are in the technology sector, the second number of patent assets owned by the company across a plurality of technology sectors, and the total financial metric of the company; and
estimating the overall financial metric of the technology sector based on the financial metric of the company in the technology sector.

14. The method of claim 9, wherein estimating the overall financial metric of the technology sector comprises:
determining, from the plurality of patent assets, a number of patent assets that are owned by at least one company and are in the technology sector;
determining a financial metric per patent asset in the technology sector based on financial metrics of other companies in the technology sector; and
estimating the overall financial metric of the technology sector based on the financial metric per patent asset and the number of patent assets that are owned by the at least one company and are in the technology sector.

15. The method of claim 9, wherein estimating the overall financial metric of the technology sector comprises:
for at least one patent asset of the patent assets:
determining a respective financial metric for the patent asset, the respective financial metric being based on a patent office classification of the patent asset; and
estimating the overall financial metric of the technology sector based on the respective financial metric for the patent asset.

16. The method of claim 9, wherein generating the output for the client device comprises generating a report of the technology sector based on the overall financial metric of the technology sector.

17. A non-transitory computer-readable medium storing instructions, the instructions when executed by a processor cause the processor to perform the method of:
receiving, from a client device, information identifying a technology sector;
querying a patent database for a plurality of patent assets associated with the technology sector;
estimating an overall financial metric of the technology sector based on the plurality of patent assets associated with the identified technology sector; and
generating an output for the client device based on the overall financial metric of the technology sector.

18. The non-transitory computer-readable medium of claim 17, wherein estimating the overall financial metric of the technology sector comprises estimating an overall revenue of the technology sector based on the plurality of patent assets associated with the identified technology sector.

19. The non-transitory computer-readable medium of claim 17, the instructions further comprising instructions for:
identifying a plurality of companies that own the plurality of patent assets associated with the technology sector;
wherein the overall financial metric of the technology sector is estimated based further on the identified plurality of companies that own the plurality of patent assets associated with the technology sector.

20. The non-transitory computer readable medium of claim 17, wherein generating the output for the client device comprises generating a report of the technology sector based on the overall financial metric of the technology sector.
